(19) United States
(12) Patent Application Publication
(10) Pub. No.: US 2008/0045066 A1
(43) Pub. Date: Feb. 21, 2008

(54) Seal for Flexible Flat Cable (Ffc), Fpc and Other Flat Cables With and Without Round Conductors

(75) Inventors: Gerhard Peter, Salz (AT); Markus Kreuter, Hohenems (AT)

Correspondence Address: K.F. ROSS P.C., 5683 RIVERDALE AVENUE, SUITE 203 BOX 900, BRONX, NY, 10471-0900, US

(73) Assignee: HIRSCHMANN AUTOMATION AND CONTROL GMBH, D- 72654 NECKARTENZLINGEN (DE)

(21) Appl. No.: 11/665,433

(22) PCT Filed: Oct. 14, 2005
(86) PCT No.: PCT/EP05/11110

§ 371 Date: Sep. 25, 2007

(30) Foreign Application Priority Data
Oct. 16, 2004 (DE) 10 2004 050 473.3
Aug. 30, 2005 (DE) 10 2005 040 941.5

(51) Int. Cl. H01R 13/52

(52) U.S. Cl. 439/271

(57) ABSTRACT

The invention relates to a sealing element (7) which can be fastened on at least one conductor (2, 4, 6) of at least one line (1, 3, 5) or the line (1, 3, 5) itself and which can be inserted into a housing (12). According to the invention, the sealing element (7) is provided with openings (8, 9, 10) for receiving the conductors (2, 4, 6). The sealing element (7) can be inserted, with or without the mating contact or line (1, 3, 5), into the housing and fastened therein before or after it is positioned on the conductors (2, 4, 6).

The invention relates to a seal, particularly for a plug or a socket of a plug connector for use in automotive technology, according to the characteristics of the preamble of claim 1.

Plugs or sockets of plug connectors for use in the automotive industry are known, where at least one electrically conductive conductor in a wire has an end provided with a contact, can be inserted and fixed in place in a contact chamber of a housing of the plug or socket. In the case of these known plugs or sockets, the end region of the wire and a part of the housing are then insert-molded using a sealing material to ensure that in the plugged-in and unplugged states of the plug or socket, ambient media (particularly moisture or pollution) is prevented from penetrating between the conductor and the wire, the conductor and the housing, and the wire and the housing. If plugs and sockets produced accordingly are assembled into a complete plug connector, the longitudinal water tightness required in automotive technology is achieved. As a result, a reliable and proven, but above all a tight connector system is provided. The disadvantage, however, is the high manufacturing cost, because accordingly designed manufacturing equipment is required for molding the sealing material around the components, the tools and operation of which system are cost-intensive. In addition, once the equipment has been set up, flexibility is limited, resulting in high expenses on the production line of the plug or the socket when changes are to be made (for example, when the number of electrical conductors decreases or increases).

It is therefore the object of the invention to provide a seal of a plug connector, which meets the longitudinal water tightness requirements in the plugged-in and unplugged states and the expenses of which are reduced during production, while its manufacturing flexibility is increased.

This object is achieved with the characteristics of claim 1.

According to the invention, a seal with openings for receiving the conductors is provided, the seal being mounted to the wire at the electrical conductors before or after attaching the contacts and being inserted into the housing and fixed in place. Hence, a single seal is provided that assumes the sealing function between the housing and the electrical conductors and/or the electrical wire. As a result, both the longitudinal water tightness and the sealing effect with respect to the housing are maintained. Since the seal is a separate part, it can be produced independently from the remaining components of the plug or socket and it can be installed manually or automatically on an assembly line when the components are assembled. The geometry of the seal is selected such that secure sealing between the housing on the one hand and the electrical conductors and/or the electrical wire on the other hand is guaranteed.

In a further development of the invention, the seal can be made of elastic and deformable material. This has the advantage that when installing the seal on the electrical conductors and/or the electrical wire on the one hand and when inserting the seal into the housing of the plug or socket on the other hand, the seal can be deformed, in particularly permanently deformed, thus maintaining permanent pressure between the seal and the housing and/or the electrical conductor or the wire, resulting in the desired housing tightness and longitudinal water tightness. Furthermore, tolerances are compensated for. To achieve the elastic deformation and the resulting permanent pressure effect, it is provided that the outer cross-section of the seal is slightly larger than the inner cross-section of the housing. As a result, the seal is compressed when inserted into the housing and comes in contact all around on the housing of the plug or socket. Additionally or alternatively, it is provided that the cross-section of the openings in the seal corresponds to the cross-section of the wire or the cross-section of the conductors and is selected slightly smaller than that cross-section. Hence, it is guaranteed that the seal bears against at least one electrical conductor and/or the wire, at the same time achieving the housing and longitudinal water tightness between these two components.

Overall, the seal according to the invention offers the advantages that both manual and automatic assembly of the seal are possible. In the case of automatic assembly of the seal, this step can be easily integrated into an assembly line, eliminating complex tools for producing a seal. Typically, a wire with a plurality of conductors is used, for example flat cables (FFC: flexible flat cable, FPC: flexible printed circuit), ribbon cables or individual cables with bunched conductors. These typically have a defined spacing (grid spacing) between the individual conductors. The seal according to the invention has the advantage that the grid spacing is not limited by the seal. Depending on the design (particularly the diameter) of the electrical conductors and/or the electrical wire, the grid spacing and the number of electrical conductors, the seal can be prefabricated accordingly. It is conceivable to prefabricate a plurality of seals with different numbers of openings, wherein during assembly of the plug or socket always that seal is used that has same number of openings as the number electrical conductors that are provided. It is also conceivable to use different colors, for example, for differentiating the different seals.

Further embodiments of the invention are provided in the dependent claims, described hereinafter and explained with reference to the figures, where the invention is not limited to these illustrated embodiments. Shown are:

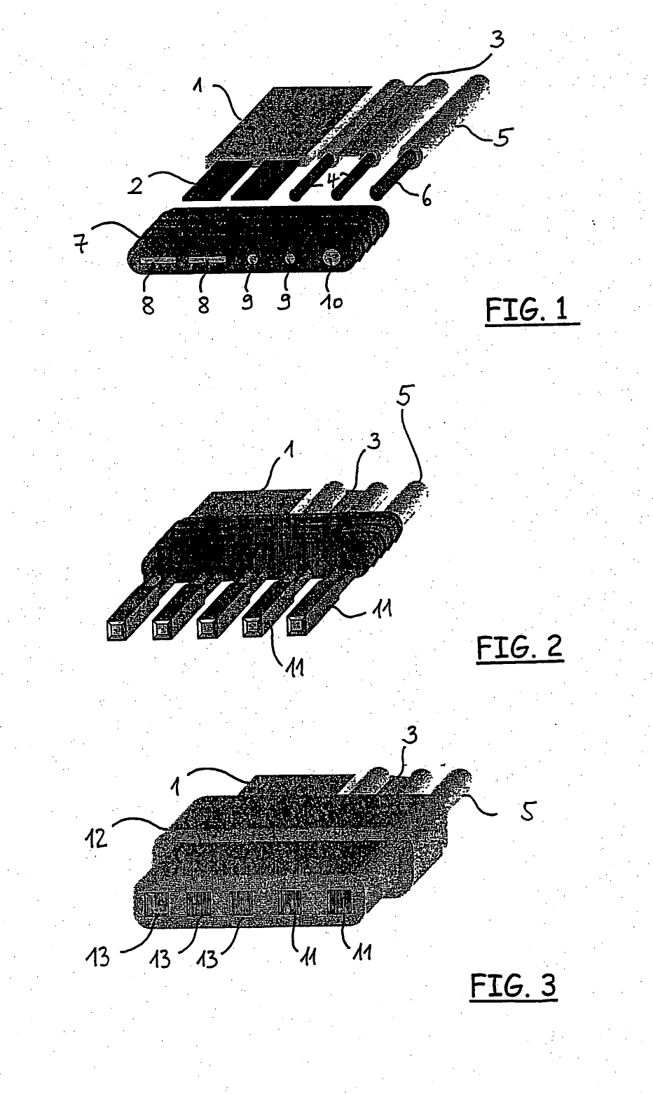

FIGS. 1 to 3: the basic configuration of a plug or socket,

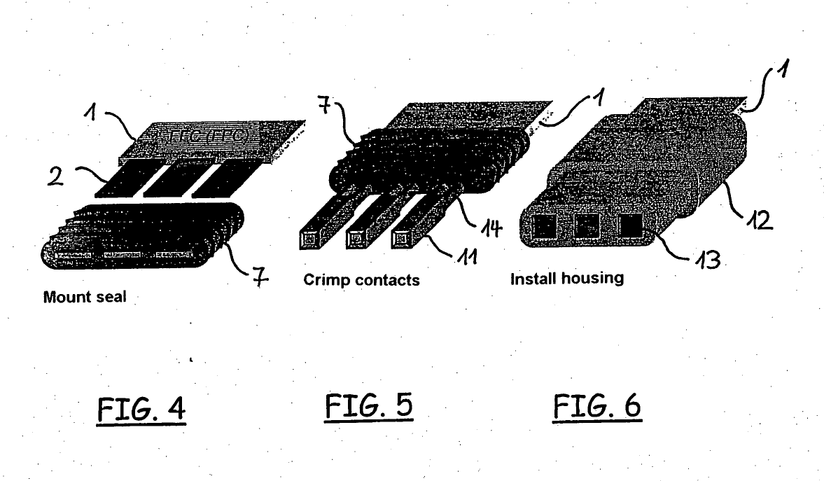

FIGS. 4 to 6: the manufacturing method of a socket with flat cable,

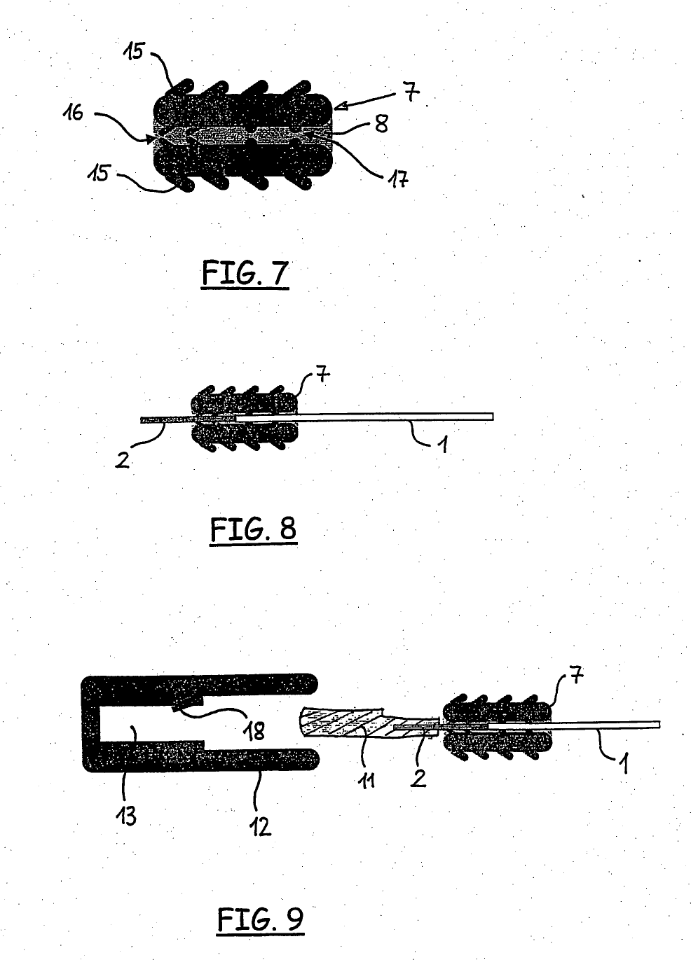

FIGS. 7 to 9: one embodiment of a seal.

FIGS. 1 to 3 illustrate, to the extent details are provided, the basic design of a seal according to the invention. It is shown that different wires can be used together. In general, this only serves the illustration of the invention, where in the embodiments typically only one type of wire is used. The hybrid assembly shown according to FIGS. 1 to 3, however, is not excluded in practical applications.

A flat cable 1 (FFC or FPC), denoted with reference numeral 1, is shown that comprises parallel electrical conductors 2 (flat conductors) extending at a spacing from each other. Additionally or alternatively, the use of a ribbon cable 3 is conceivable that also comprises parallel electrical conductors 4 extending at a spacing from each other. These electrical conductors 4 are configured as stranded conductors, for example. Furthermore, additionally or alternatively, the use of a single wire 5 is conceivable that also comprises an electrical conductor 6 that is configured likewise, for example, as a stranded conductor. The wires 1, 3, and 5 shown and described therefore comprise a plurality of electrical conductors 2, 4, and 6 that are enclosed on the outside by insulation.

According to the invention, a seal 7 with openings 8, 9, and 10 is provided, which openings 8, 9, and 10 correspond substantially to the cross-section of the electrical conductors 2, 4, and 6. It is apparent, for example, that the openings 8 have a substantially rectangular cross-section that corresponds to the cross-section of the electrical conductor 2 of the flat cable 1. This prefabricated seal 7 that is made particularly of elastic and deformable material, is pushed over the end region of the wires 1, 3, and 5 and fixed in place there in a defined position. Before or after installing the seal 7 on at least one wire end, the electrical conductors 2, 4, and 6 are uncovered (stripped).

FIG. 2 shows that the seal 7 has been placed on the wires 1, 3, and 5 and fixed in place there. This positioning can be achieved, for example, in that the cross-section of the openings 8, 9, and 10 on an elastic and deformable seal 7 is selected slightly smaller than the cross-section of the wires 1, 3, and 5 and/or of the electrical conductors 2, 4, and 6, wherein additionally or alternatively it is conceivable to fix the seal 7 in position by additional measures (such as gluing). After (or alternatively before) installing the seal 7 on the electrical wires 1, 3, and 5, in this embodiment contacts 11 are crimped, meaning the installation and attaching of contacts 11 on the electrical wires 2, 4, and 6. This is done by means of known bonding techniques, such as soldering, welding, crimping or the like.

FIG. 3 shows that the end region of the wires 1, 3, and 5 illustrated according to FIG. 2 is provided with a housing 12, the housing 12 having prefabricated contact chambers 13. The end region prefabricated according to FIG. 2 is inserted into the housing 12, so that the contacts 11 are inserted and fixed (locked) in the contacts 13. In doing so, the seal 7 is also inserted completely or at least partially into the housing 12, the housing 12 having an inside surface shape that corresponds to the outside surface shape of the seal 7. After this last step, the socket shown according to FIG. 3 (the contacts 11 are configured as socket connectors) is finished, as a result of which the seal 7 that bears tightly against the housing 12 on the one hand and against the wires 1, 3, and 5 as well as the conductors on the other hand, produces the desired housing and longitudinal water tightness. When the socket produced this way is plugged into a similarly produced plug (for which purpose the contacts are then configured as plug pins) to form a plug connector, longitudinal water tightness is guaranteed across the entire longitudinal extension of, the plug connector and the wires connected thereto, so that no ambient media can penetrate into the contact region anywhere on the wires or the plug connector.

FIGS. 4 to 6 show and describe the entire sealing system again, as well as the assembly thereof, based on a socket for a flat cable. In FIG. 4, the prepared end of the flat cable 1 can be seen with the exposed conductors 2 and the prefabricated seal 7. FIG. 5 shows that the seal 7 has been pushed over the prepared end of the flat cable 1 and fixed in place there. For this purpose, in a previous step the electrical conductors 2 of the flat cable 1 have been stripped of their insulation along such a length that the contact 11 can be crimped to the electrical conductor, particularly by means of a crimp connection 14. This crimp connection 14 has the significant advantage that it is durable and gas-tight, to prevent contact resistance or open circuits during the service life of the finished socket. On the other hand, the crimp connection 14 has the advantage that no heat is required, so that the adjoining seal 7 is not damaged. If the contacts are secured to the conductors before placing on the seal 7, this can also be done by crimping, soldering or welding. As a result, the seal 7 is protected from the heat caused by soldering or welding. The seal 7 in turn is pushed over the flat cable 1 (or more precisely the insulation thereof) on the one hand and over the electrical conductors 2 on the other hand and bears against them. The end region of the flat cable 1 prepared according to FIG. 5 is then inserted into the housing 12 of the socket, as shown in FIG. 6, so that the contacts 11 are fixed in place in the contact chambers 13 of the housing 12. In the region of the housing 12 facing away from the contact chambers 13, the housing is shaped to receive the seal 7 such that also in this area the seal 7 contact bears against the inside surface of the housing 12. The sealing effect between the seal 7 on the one hand and the housing 12 and/or the flat cable 1 on the other hand can optionally be improved by an adhesive connection (for example adhesive film on one of the involved elements or on both), by applying oil, lubricant or the like, however this step is not required. For example, a silicone seal already contains an oil film that significantly improves the sealing effect.

FIGS. 7 to 9 show and describe a particularly advantageous embodiment of a seal 7. FIG. 7 shows a seal 7 in cross section, various lips 15, 16, and 17 being apparent that are integrally formed during production of the seal 7. The outer shape of the seal 7 is provided with at least one, particularly a plurality of parallel lips 15, pointing toward the housing 12. These lips are provided perpendicularly or at an angle on the surface of the seal 7 and are deformed when inserting the seal 7 into the housing 12 to establish the sealing effect. Additionally or alternatively, lips 16 and 17 are provided on the inside of the seal 7 (in the region of an opening 8, 9, or 10), which lips are likewise oriented perpendicularly or at an angle. The lips 16 point toward the electrical conductors 2, 4, and 6 and the lips 17 point toward the wires 1, 3, and 5. The material and the shape of the lips 15, 16, and 17 and the material thereof are selected such that they become permanently deformed when fitting the seal 7 on the electrical wire 1, 3, and 5 or inserting it into the housing 12. As a result, the seal 7 may comprise, for example, an elastic, but not deformable core, on which the elastic and deformable lips 15, 16, and 17 are provided. Advantageously, however, the entire seal 7, including the lips 15, 16, and 17 thereof, is made of elastic and deformable material, so that it can be produced as one piece. The lips 17 are configured such that they bear against the electrical wire 1 (FIG. 8) and also fill in the regions between the electrical wires (lips 17). FIG. 9 shows the seal 7 that has been pushed onto the end region of the wire 1, where subsequently the contact 11 has been attached to the electrical conductor 2. The tightness inside the seal 7 has already been established, the longitudinal water tightness being achieved outside the seal 7 by inserting it into the housing 12. To fix the seal 7 in position inside the housing 12, the housing comprises an abutment 18 that interacts with one of the lips 15. The abutment 18 can, alternatively or additionally, also only be intended only for the contact. After the seal 7 has been inserted into the housing 2, it either is received entirely in the housing 12 or protrudes partly outside, further providing bending protection. In the view according to FIG. 8 it should also be added that one or more abutments 18 may be provided in the region of larger cross section (insertion region) of the housing 12, these abutments preferably, but not necessarily, corresponding to the lips 5 of the seal 7.

While in the description above electrical conductors are mentioned, the sealing system according to the invention can also be used for other types of wires (for example fiber-optic cables), in branching devices, in housings of electrical or electronic devices and the like. No limitations of the application of the special seal according to the invention on plugs or sockets are provided.

The invention relates in particular to a seal for the following applications:

1. Flat-cables (FFC, FPC, etc.), and the seal should also be usable for single-pin wires.

2. It is also possible to combine a plurality of is conductors.

3. Different types of conductors (flat cable, ribbon cable, wire, stranded conductor etc.) combined into one seal are likewise possible.

4. it is ideal when equivalent wires, such as stranded wires, can be combined. LIST OF REFERENCE NUMERALS 10. Passage 1. Flat cable 11. Contact 2. electrical conductor 12. Housing 3. ribbon wire 13. Contact chamber 4. electrical conductor 14. Crimp connection 5. individual wire 15. Lip (on housing side) 6. electrical conductor 16. Lip (on electrical 7. Seal conductor) 8. Passage 17. Lip (on flat cable) 9. Passage 18. Abutment

1. A seal that can be attached to at least one conductor or at least one wire and that can be inserted in a housing, characterized in that the seal is provided with openings for receiving the conductors, the seal being insertable into the housing and fixable in place before or after a installing it on the electrical conductors or the wire.

2. The seal according to claim 1, characterized in that the seal can be pulled on the wire before or after installing the contacts on the conductors.

3. The seal according to claim 1, characterized in that the seal is made of elastic and deformable material.

4. The seal according to claim 1, characterized in that a cross-section of the openings corresponds to a cross-section of the wire or a cross-section of the conductors and is set slightly smaller than them.

5. A seal according to claim 1, characterized in that an outer cross-section of the seal is slightly larger than an inner cross-section of the housing.

6. A seal according to claim 1, characterized in that the seal comprises at least one lip.

7. The seal according to claim 6, characterized in that the lip extends perpendicular or at an angle, pointing toward the housing and bearing thereon.

8. The seal according to claim 6, characterized in that the lip extends perpendicular or at an angle, pointing toward the housing and bearing thereon.

9. The seal according to claim 6, characterized in that the lip extends perpendicular or at an angle, pointing toward the housing and bearing thereon.

10. The seal according to claim 6, characterized in that the housing comprises at least one abutment for at least one lip.

11. The seal according to claim 1, characterized by the use of same between a housing of a plug or a socket and a wire insertable therein with conductors, a contact being provided on the ends of the conductors that can be inserted in a contact chamber of the housing and fixed in place there.
